(19) United States
(12) Patent Application Publication
(10) Pub. No.: US 2014/0223978 A1
(43) Pub. Date: Aug. 14, 2014

(54) PARTICLE OF MICROBIAL FERTILIZER

(71) Applicant: CHUNGHWA PICTURE TUBES, LTD., Taoyuan (TW)

(72) Inventors: Chou-Chiang Kuo, New Taipei City (TW); Che-Wei Chang, Taoyuan County (TW)

(73) Assignee: CHUNGHWA PICTURE TUBES, LTD., Taoyuan (TW)

(21) Appl. No.: 13/832,028

(22) Filed: Mar. 15, 2013

(30) Foreign Application Priority Data
Feb. 8, 2013 (TW) 102105318

(51) Int. Cl. C05F 11/08

(52) U.S. Cl. CPC C05F 11/08
USPC 71/6

(57) ABSTRACT

A particle of a microbial fertilizer is provided, and includes the following components that are well-mixed: a culture solution containing probiotic endospores, an aqueous solution of polyol, a bio-degradable filler material, a bio-degradable polymer, and a nutritive substance. The particle of the microbial fertilizer extends storage time of the microbial fertilizer and maintains viability of probiotics, and thus effects of a microbial agent are successfully achieved.

### CROSS-REFERENCE TO RELATED APPLICATION

This application claims the priority benefit of Taiwan application serial no. 102105318, filed on Feb. 8, 2013. The entirety of the above-mentioned patent application is hereby incorporated by reference herein and made a part of this specification.

### FIELD OF THE INVENTION

The invention relates to a fertilizer, and more particularly, to a particle of a microbial fertilizer.

### DESCRIPTION OF RELATED ART

Microbial agents include microbial pesticides and microbial fertilizers. Generally, in terms of usage, the microbial agents are still used in the usual manner of using conventional chemical fertilizers and pesticides, which is that solutions of the microbial agents are applied directly to a soil surface layer by spraying.

Since the microbial agents substantially include living probiotics or dormant spores of the probiotics, the aforementioned spraying method is likely to reduce viability of the probiotics or their spores. That is to say, under conditions that the probiotics or their spores are sprayed to the soil surface layer to be exposed to some factors (e.g. ultraviolet, natural enemies, etc.) in nature that are unfavorable for survival, the viability of these microorganisms is considerably reduced. As a result, effects of the microbial agents fail to be achieved.

### SUMMARY OF THE INVENTION

The invention provides a particle of a microbial fertilizer having an extended application cycle and better effects.

The particle of the microbial fertilizer of the invention includes the following components that are well-mixed: a culture solution containing probiotic endospores, an aqueous solution of polyol, a bio-degradable filler material, a bio-degradable polymer, and a nutritive substance.

In an embodiment of the invention, a content of the bio-degradable filler material is in a range of 56.7 wt % to 77.3 wt %.

In an embodiment of the invention, a content of the aqueous solution of polyol is in a range of 10.3 wt % to 15.4 wt %.

In an embodiment of the invention, a content of the bio-degradable polymer is in a range of 10.3 wt % to 30.9 wt %.

In an embodiment of the invention, a content of the nutritive substance is in a range of 2.1 wt % to 8.2 wt %.

In an embodiment of the invention, the culture solution containing probiotic endospores comprises a bacillus.

In an embodiment of the invention, the bio-degradable filler material comprises a starch.

In an embodiment of the invention, the bio-degradable polymer comprises a bio-degradable polyester.

In an embodiment of the invention, the bio-degradable polymer comprises at least one selected from a group consisting of polybutylene succinate) (PBS), polylactic acid (PLA), polyhydroxyalkanoate (PHA) and poly-β-hydroxybutyrate (PHB).

In an embodiment of the invention, the nutritive substance comprises a maltodextrin.

Based on the above, the particle of the microbial fertilizer of the invention causes the probiotic endospores to be substantially coated and immobilized in the particle of the microbial fertilizer by well mixing the culture solution containing the probiotic endospores with each component. In this way, when the particle of the microbial fertilizer is buried in farmland soil, the probiotic endospores are released from degradation of the other components and are able to grow without being easily affected by unfavorable factors for survival such as ultraviolet and natural enemies. Therefore, effects of the probiotic endospores are successfully achieved.

To make the above features and advantages of the invention more comprehensible, embodiments accompanied with drawings are described in detail as follows.

### BRIEF DESCRIPTION OF THE DRAWINGS

FIG. 1 illustrates a manufacturing method of a particle of a microbial fertilizer according to an embodiment of the invention.

### DESCRIPTION OF THE EMBODIMENTS

The invention provides a particle of a microbial fertilizer including the following components that are well-mixed: a culture solution containing probiotic endospores, an aqueous solution of polyol, a bio-degradable filler material, a bio-degradable polymer, and a nutritive substance.

The culture solution containing probiotic endospores comprises probiotic endospores mainly providing effects of fertilization. In an embodiment, the culture solution containing probiotic endospores is, for example, a culture solution containing endospores of concentrated probiotics prepared by fermentation culture. The probiotics are, for example, bacilli. The culture solution is, for example, a nutrient broth (NB) medium. The aqueous solution of polyol serves as a plasticizer, and is, for example, an aqueous solution of diol such as 1,2-propanediol or an aqueous solution of triol such as glycerol.

The bio-degradable filler material serves as, for example, a main component to coat the probiotic endospores. Accordingly, before being released, the probiotic endospores obtain a sufficient protection against destruction and influence from external environments. The bio-degradable filler material is, for example, a natural starch, a modified starch, cellulose, diatomaceous earth, and a mineral salt such as calcium carbonate. The bio-degradable polymer provides, for example, a mechanical strength so that the formed particle of the microbial fertilizer has both flexibility and rigidity. The bio-degradable polymer is, for example, a bio-degradable polyester including at least one selected from a group consisting of poly(butylene succinate) (PBS), polylactic acid/polylactide (PLA), polyhydroxyalkanoate (PHA) and poly-β-hydroxybutyrate (PHB). The nutritive substance provides nutrition required for germination and growth of the probiotic endospores. The nutritive substance is, for example, a maltodextrin, a yeast extract, or a trace element.

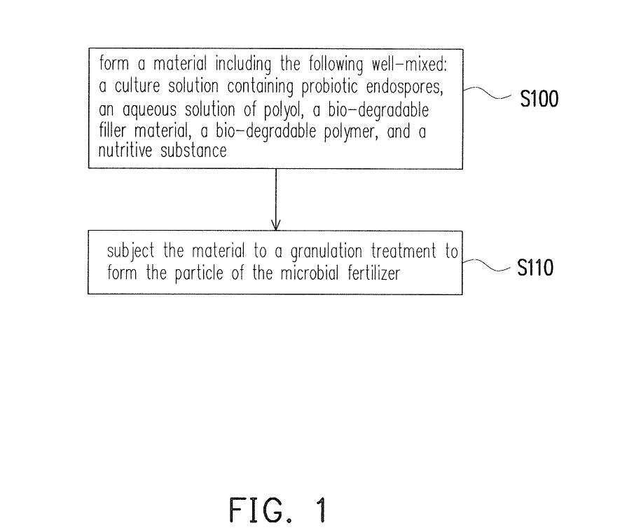

A manufacturing method of the particle of the microbial fertilizer is described hereinafter with reference to FIG. 1. It should be noted that the manufacturing method of the particle of the microbial fertilizer described in FIG. 1 and the following paragraphs is only one of several manufacturing methods of the particle of the microbial fertilizer, and serves merely to exemplify the invention rather than to limit the invention.

FIG. 1 illustrates a manufacturing method of the particle of the microbial fertilizer according to an embodiment of the invention. Referring to FIG. 1, in the present embodiment, first, step S100 is executed to form a material. This material includes a culture solution containing probiotic endospores, an aqueous solution of polyol, a bio-degradable filler material, a bio-degradable polymer, and a nutritive substance, which are well-mixed. In this material, a content of the bio-degradable filler material is, for example, in a range of 55 wt % to 75 wt %, a content of the aqueous solution of polyol is, for example, in a range of 10 wt % to 15 wt %, a content of the bio-degradable polymer is, for example, in a range of 10 wt % to 30 wt %, and a content of the nutritive substance is, for example, in a range of 2 wt % to 8 wt %. In detail, the culture solution containing probiotic endospores and the aqueous solution of polyol are stirred at normal temperature to be well mixed together to obtain a mixed liquid for later use. On the other hand, the bio-degradable filler material, the bio-degradable polymer, and the nutritive substance, for example, are well mixed to obtain a mixture for later use. Next, by well stirring the aforementioned mixed liquid and mixture, the mixed liquid of the culture solution containing probiotic endospores and the aqueous solution of polyol are well mixed with the mixture of the bio-degradable filler material, the bio-degradable polymer and the nutritive substance, so as to form the material. Of course, the aforementioned mixed liquid and mixture may further include other substances according to requirements. It is to be noted that, to prevent the probiotic endospores from inactivation due to destruction of factors such as heat, the aqueous solution of polyol, the bio-degradable filler material, the bio-degradable polymer and the nutritive substance may be well mixed in advance, and finally the culture solution containing probiotic endospores is added thereto to form the material.

Then, as shown in step S110, the material is subjected to a granulation treatment to form the particle of the microbial fertilizer. In an embodiment, a method of manufacturing the material into particles is, for example, guiding the material into an extruding machine to perform a mixing process to form elongated objects, and then cutting the elongated objects into particles of appropriate sizes. A process temperature of the mixing process is mainly determined by a melting point of the bio-degradable polymer. For example, these steps may be executed at temperatures of 5° C. to 10° C. higher than the melting point of the bio-degradable polymer. For example, when the bio-degradable polymer is a poly(butylene succinate), the mixing process by the extruding machine includes, for example, the following four manufacturing processes that are sequentially performed: the first manufacturing process is a preheating process at a temperature of, for example, 100° C. to 105° C.; the second manufacturing process is a first extrusion process at a temperature of, for example, 115° C. to 120° C.; the third manufacturing process is a second extrusion process at a temperature of, for example, 115° C. to 120° C. and different extrusion manner is performed on the material in the first extrusion process and the second extrusion process by the screw; and the fourth manufacturing process is a cooling process at a temperature of, for example, 95° C. to 100° C. The extruding machine is, for example, a single-screw extruder or a twin-screw extruder. In an embodiment, a screw rotational speed is for example, 40 rpm to 50 rpm. An average process retention time is, for example, 3 to 5 minutes. In an embodiment, the particle of the microbial fertilizer is, for example, a cylindrical particle, wherein the cylindrical particle has, for example, a height of smaller than 1 cm and a diameter of approximately 0.3 cm to 0.5 cm.

In addition, after being manufactured, the particle of the microbial fertilizer is further subjected to a baking process for the benefit of being dried and stored at room temperature. The baking process is, for example, carried out in a baking box at approximately 40° C. for approximately 24 hours. After the baking process is completed, a portion of water in the particle of the microbial fertilizer is removed. Accordingly, in the particle of the microbial fertilizer, the content of the bio-degradable filler material is, for example, in a range of 56.7 wt % to 77.3 wt %, the content of the aqueous solution of polyol is, for example, in a range of 10.3 wt % to 15.4 wt %, the content of the bio-degradable polymer is, for example, in a range of 10.3 wt % to 30.9 wt %, and the content of the nutritive substance is, for example, in a range of 2.1 wt % to 8.2 wt %.

In an embodiment of the invention, by well mixing the material including the culture solution containing probiotic endospores, the aqueous solution of polyol, the bio-degradable filler material, the bio-degradable polymer and the nutritive substance and subjecting the same to a forming process, the particle of the microbial fertilizer is manufactured. The probiotic endospores are coated with substances mostly bio-degradable and able to provide nutrition, and are immobilized in the formed particle. Therefore, the formed particle is also referred to as an “immobilized” particle of the microbial fertilizer. An application method of the particle of the microbial fertilizer is directly burying the particle of the microbial fertilizer in farmland soil, so that the bio-degradable filler material and other components that coat the particle of the microbial fertilizer are completely degraded in the soil, thus releasing the probiotic endospores. At this moment, due to humid conditions in the soil and the nutritive substance added to the particle of the microbial fertilizer, the probiotic endospores germinate and grow abundantly. In this way, the probiotics achieve effects such as soil quality improvement, plant rhizosphere protection, plant growth enhancement and so on. In addition, since the probiotics are protected in the form of endospores and by an appropriate protection technique of immobilization, the probiotics are prevented from being affected by external environments before growing properly. Accordingly, storage time of the microbial fertilizer is considerably extended, viability of the probiotics is maintained, and thus effects of a microbial agent are successfully achieved.

In summary, the particle of the microbial fertilizer of the invention includes the following well-mixed: the culture solution containing probiotic endospores, the aqueous solution of polyol, the bio-degradable filler material, the bio-degradable polymer, and the nutritive substance. The probiotics in the particle of the microbial fertilizer exist in the form of endospores and are substantially coated, immobilized and protected in the particle of the microbial fertilizer. In this way, when the particle of the microbial fertilizer is buried in farmland soil, the probiotic endospores are released from degradation of the other components and grow, thereby successfully achieving the effects thereof. Accordingly, the application cycle of a microbial agent is effectively extended and the effects thereof are improved. Also, it is favorable for long tern storage of the microbial agent. In addition, a degradation speed of the particle of the microbial fertilizer may be controlled by adjusting proportions of each component in the particle. Hence appropriate particles of the microbial fertilizer may be manufactured in accordance with different planting environments or plant species. Furthermore, the particle of the microbial fertilizer has properties of easy processing and mass production, low manufacturing cost, easy storage and simple application, and thus may be widely applied to microbial agents for purposes of developing agricultural planting technology.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A particle of a microbial fertilizer comprising the following components that are well-mixed:
a culture solution containing probiotic endospores;
an aqueous solution of polyol;
a bio-degradable filler material;
a bio-degradable polymer; and
a nutritive substance.

2. The particle of the microbial fertilizer as claimed in claim 1, wherein a content of the bio-degradable filler material is in a range of 56.7 wt % to 77.3 wt %.

3. The particle of the microbial fertilizer as claimed in claim 1, wherein a content of the aqueous solution of polyol is in a range of 10.3 wt % to 15.4 wt %.

4. The particle of the microbial fertilizer as claimed in claim 1, wherein a content of the bio-degradable polymer is in a range of 10.3 wt % to 30.9 wt %.

5. The particle of the microbial fertilizer as claimed in claim 1, wherein a content of the nutritive substance is in a range of 2.1 wt % to 8.2 wt %.

6. The particle of the microbial fertilizer as claimed in claim 1, wherein the culture solution containing probiotic endospores comprises a bacillus.

7. The particle of the microbial fertilizer as claimed in claim 1, wherein the bio-degradable filler material comprises a starch.

8. The particle of the microbial fertilizer as claimed in claim 1, wherein the bio-degradable polymer comprises a bio-degradable polyester.

9. The particle of the microbial fertilizer as claimed in claim 1, wherein the bio-degradable polymer comprises at least one selected from a group consisting of poly(butylene succinate) (PBS), polylactic acid (PLA), polyhydroxyalkanoate (PHA) and poly-β-hydroxybutyrate (PHB).

10. The particle of the microbial fertilizer as claimed in claim 1, wherein the nutritive substance comprises a maltodextrin.
